(19) United States
(12) Patent Application Publication
(10) Pub. No.: US 2004/0189717 A1
(43) Pub. Date: Sep. 30, 2004

(54) Intelligent drill-down for graphical user interface

(76) Inventors: Carli Conally, Ft. Collins, CO (US); Kay C. Lannen, Ft. Collins, CO (US); Bonnie Sue Hautamaki, Loveland, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/400,051

(22) Filed: Mar. 27, 2003

(51) Int. Cl. G09G 5/00

(52) U.S. Cl. 345/853

(57) ABSTRACT

A graphical user interface with intelligent drill-down capability is presented. On various views of data objects in the graphical user interface, a drill-down mechanism is provided. Data objects may include lists, tables, charts, or graphics. When the drill-down mechanism is activated, preferably via a one-step activation method, child data objects containing detailed information about the parent data object are automatically displayed. The data objects displayed are automatically selected based on the context of the parent data object.

### FIELD OF THE INVENTION

The present invention relates generally to graphical user interfaces for computerized devices, and more particularly to an intelligent method and interface for presenting context-specific drill-down information associated with displayed data in a graphical user interface.

BACKGROUND OF THE INVENTION

The increasing reliance upon computer systems to collect, process, and analyze data has led to the continuous improvement of the system assembly process and associated hardware and software. As hardware continues to improve in terms of size, speed, and efficiency, there has been an increased focus on the ease of usability of computerized products. In particular, manufacturers of computerized devices that integrate a display interface, or graphical user interface, into the devices are increasingly interested in the ease of use of the interface to the operator of the device.

Some graphical user interfaces are used to display data collected for one or more attributes, measurements, or metrics of interest. As used herein, an attribute is a characteristic of an item, a measurement is a measured value, and a metric is a calculation based on one or more attributes and/or measurements. While collected data can be displayed in simple list or tabular form, if the object of the application is to allow the operator to draw conclusions from the collected data, it is often more useful to display the collection of data in the format of some sort of chart (e.g., a line graph, a pareto chart, etc.) which allows the operator to visually detect trends in the data. Depending on the application, these charts may be sufficient for complete analysis of the data. However, in many instances, detecting a trend is the first step in a long analysis process. In these cases, it may be useful to display additional information about the collected data or present it in other visually useful formats with or without data filtering.

The ability to display additional information for a given view of a data object is referred to herein as “drill-down” capability. Currently there exist graphical user interface methods that provide some form of drill-down capability. In some products, when a particular view of a data object is displayed, the graphical user interface may allow the operator to enter filter information to display additional information and/or charts. In other products, the graphical user interface provides a list of possible drill-down filters that the operator may choose from.

The prior art drill-down capability is problematic for several reasons. First, in prior art graphical user interfaces that provide some sort of drill-down capability, the operator must manually set up the filter and/or determine a filter that makes sense to apply to the attribute, measurement, or metric that is currently being viewed. In order to obtain a useful drill-down, the operator must have an understanding of how each possible filter applies to the real problem at hand. Another disadvantage to the prior art approaches is that typically only a single filter can be applied and displayed at any given time. Thus, the original view and the filtered view cannot be displayed simultaneously to allow visual comparison. In addition, multiple filtered drill-down views also cannot be simultaneously displayed, which makes it difficult to easily compare the results of several filters at one time to look for a meaningful trend.

It would therefore be desirable to provide the capability for displaying multiple data objects to allow visual comparison of the data objects. It would also be desirable to have a more efficient and proven approach for automatically obtaining drill-downs without requiring operator filter set-up. It would be further desirable to have the drill-downs automatically configured and grouped in meaningful ways to allow the operator to more quickly understand the root causes of a symptom or trend observed by a live chart or other monitoring object. It would further be desirable to have a tool that assists the operator in intelligently grouping the data in order to discover these trends.

### SUMMARY OF THE INVENTION

The present invention is a graphical user interface with intelligent drill-down capability. The graphical user interface provides context-sensitive information which, in the preferred embodiment, allows the operator to troubleshoot process problems. On various views of data objects in the graphical user interface, a drill-down mechanism is provided. Data objects may include lists, tables, charts, or graphics. When the drill-down mechanism is activated, preferably via a one-step activation method, more child data objects containing detailed information about the parent data object are automatically displayed. The data objects displayed are selected based on the context of the parent data object. In a preferred embodiment, data objects allow data point selection that operate as filters on the drill-down data objects.

Preferably, the drill-down capability is implemented as a tree that includes as many levels as makes sense to the particular application and collected data at hand, and also allows cross-referencing from one branch of the tree to another. Thus, a data object with drill-down capability is considered a parent data object of its drill-down data object(s), and each drill-down data object is considered a child of its parent data object. Preferably, each child data object includes a drill-up button to allow the operator to return to the parent data object. In addition, each child data object may in turn be considered a parent data object to its own child data object(s) if more data is available to drill-down to.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1A is a plan view of a window of a graphical user interface screen that offers drill-down capability in accordance with the invention;

FIG. 1B is a plan view of a graphical user interface screen showing drill-down data objects upon drill-down from a parent data object;

FIG. 2A is a tree diagram illustrating data object relationships for a graphical user interface that provides simple drill-down capability;

FIG. 2B is a tree diagram illustrating data object relationships for a graphical user interface with drill-down capability showing a shared data object where each of the parent data objects resides on the same tree level;

FIG. 2C is a tree diagram illustrating data object relationships for a graphical user interface with drill-down capability showing a shared data object where each of the parent data objects resides on a different tree level;

FIG. 3A is an operational flowchart illustrating a high-level use model of a drill-down button of the invention;

FIG. 3B is an operational flowchart illustrating a high-level use model of a metric selection action in accordance with the invention;

FIG. 3C is an operational flowchart illustrating a high-level use model of a drill-up button of the invention;

FIG. 4 is a block diagram of an automated tester environment;

FIG. 5A is an example screen view of a graphical user interface implemented in accordance with the invention for the automated tester environment of FIG. 4 which illustrates four data objects each with drill-down capability;

FIG. 5B is an example amodal dialog illustrating child data objects displayed when a data point of a parent data object in FIG. 5A is selected;

FIG. 5C is an example amodal dialog illustrating a child data object displayed when a data point of a child object in FIG. 5B is selected;

FIG. 6A is a plan view of a drill-down screen when one, drill-down data object is displayed;

FIG. 6B is a plan view of a drill-down screen when two drill-down data objects are displayed;

FIG. 6C is a plan view of a drill-down screen when three drill-down data objects are displayed;

FIG. 6D is a plan view of a drill-down screen when n drill-down data objects are displayed;

FIG. 6E is a plan view of a drill-down screen when two drill-down data objects are displayed at a time and having a next button to display the next drill-down object;

FIG. 6F is a plan view of a drill-down screen when two drill-down data objects are displayed at a time and having a next button to display the next drill-down object and a previous button to display the previously displayed drill-down data objects;

FIG. 6G is a plan view of a drill-down screen when two drill-down data objects are displayed at a time and having a previous button to display the previously displayed drill-down objects; and

FIG. 7 is a data object tree diagram of an illustrative embodiment of a graphical user interface implemented in accordance with the invention.

### DETAILED DESCRIPTION

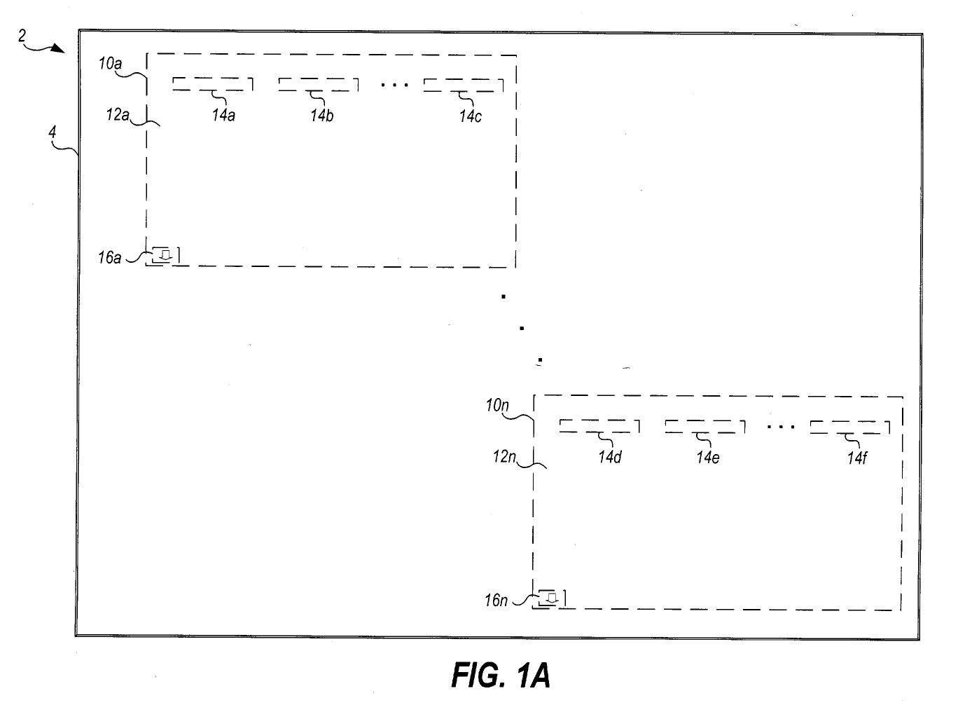

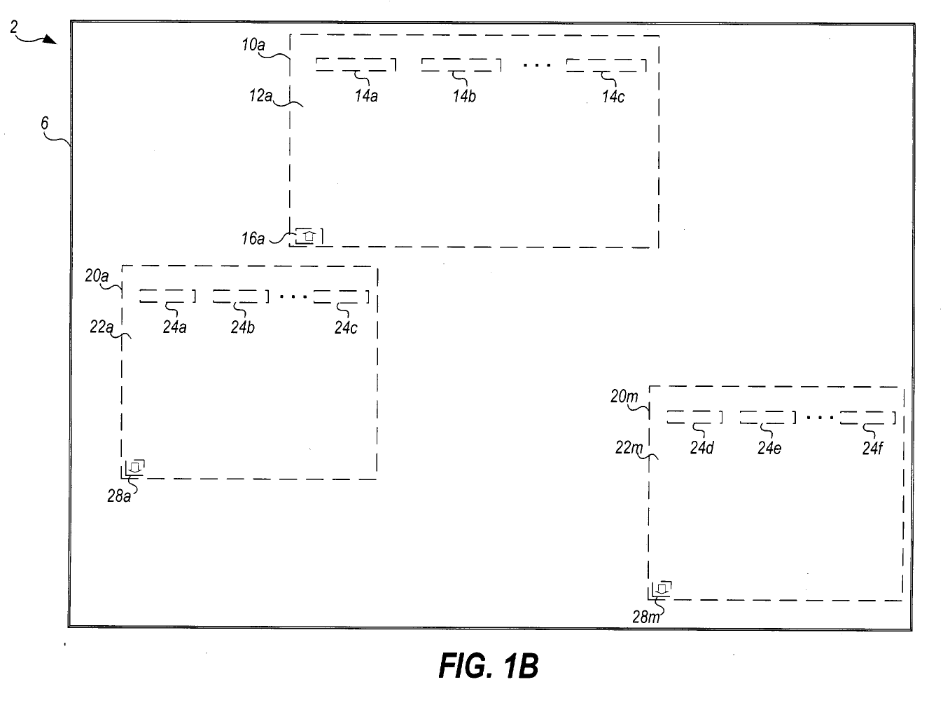

Turning now to the drawings, FIG. 1A illustrates a screen view 4 of a graphical user interface 2 that offers drill-down capability in accordance with the invention. As illustrated, the screen view 4 includes one or more parent data objects 10a, . . . , 10n each of which comprises a collection of data associated with one or more parent attributes, measurements, and/or metrics 14a, . . . , 14f. In the preferred embodiment, a data object 10a, . . . , 10n is typically displayed in the form of a chart (e.g., a line graph, a pareto chart, etc), although it could equally be displayed in the form of a list, a table, a CAD, text, or graphics. Each parent data object 10a, . . . , 10n has associated with it a drill-down mechanism 16a, . . . , 16n. In the preferred embodiment, the drill-down mechanism 16a, . . . , 16n is implemented as a button, a menu item in a drill-down menu, a hyperlink, a keyboard stroke, one or more selectable data points, or other convenient activation mechanism appropriate to the particular graphical user interface 2.

When the drill-down mechanism of a given parent data object is activated, the screen view changes to display one or more child data objects 20a, 20b, . . . , 20m associated with the given parent data object, as shown at 6 in FIG. 1B. Each child data object 20a, . . . , 20m comprises information 22a, . . . , 22m associated with the one or more data points of the parent data object 10a, 10n from which the drill-down screen view 6 was activated. In the preferred embodiment, each child data object 20a, . . . , 20m comprises data associated with one or more child data points 24a, . . . , 24f related to the parent data point(s). Again, the child data objects are also typically displayed in the form of a chart, but may also be displayed in the form of a list, a table, a CAD drawing, text, or graphics. Each drill-down view preferably includes some sort of drill-up mechanism 26a. In the preferred embodiment, the parent data object 10a of the drill-down data objects 20a, . . . , 20m is displayed simultaneously with the drill-down data objects 20a, . . . , 20m and the drill-up mechanism 26a is implemented as a drill-up button. The drill-up mechanism 26, when activated, returns the screen view to the screen view 4 from which the drill-down screen 6 was invoked. The drill-up mechanism 26a may alternatively be implemented as a menu item in a drill-down menu, a hyperlink, a keyboard stroke, or other convenient activation mechanism appropriate to the particular graphical user interface 2.

It is possible that drill-down capability may be extended beyond a single parent-child relationship. For example, a given application may lend itself to collecting additional data related to one or more child data points of a given child data object 20a, . . . , 20m. If so, the child data object 20a, . . . , 20m may have associated with it its own drill-down mechanism 28a, . . . , 28m, which when activated, changes the screen view to display one or more of its own associated child data objects. In this case, the child data object 20a, . . . , 20m operates as both a child data object (with a drill-up mechanism which returns the view to the screen view of its parent data object 10a, . . . , 10n) and as a parent data object (with a drill-down mechanism which changes the screen view to show the data objects of its children). The hierarchy of parent-child relationships may continue on as many levels as appropriate to the application. Whenever a displayed data object operates as a child data object, it always includes a drill-up mechanism to allow the operator to return to the view from which it was activated. Likewise, whenever a displayed data object operates as a parent data object, it always includes a drill-down mechanism to allow the operator to view its associated child data object(s). The lack of a drill-down mechanism on a given data object may be used to indicate that no additional drill-down data is available for that object.

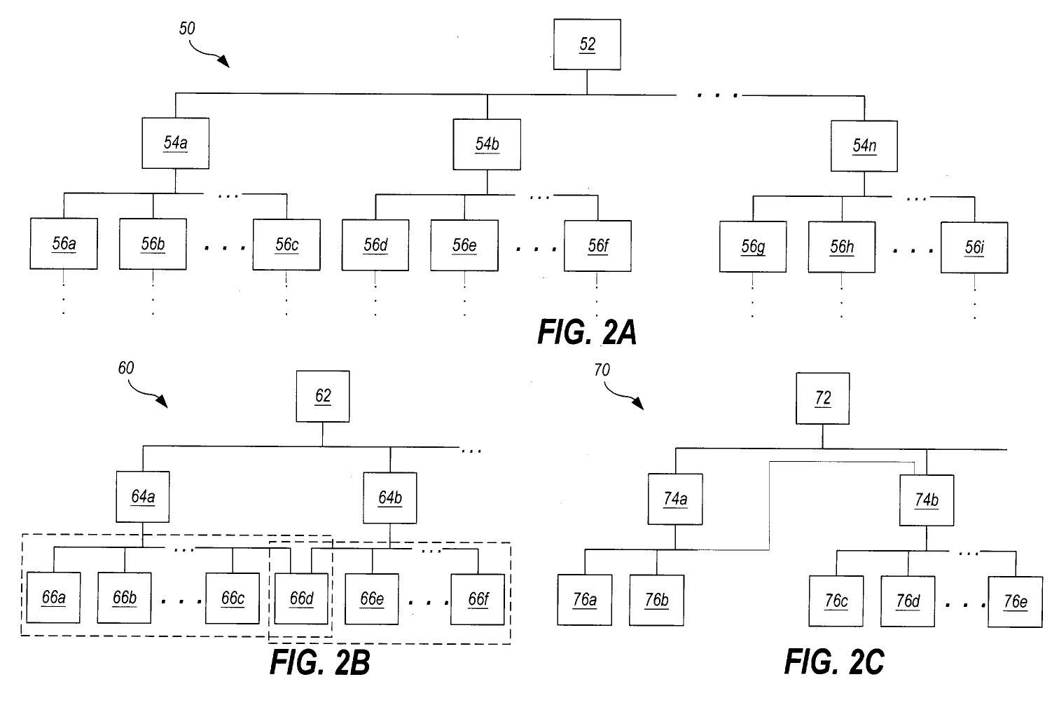

FIG. 2A is a tree diagram 50 illustrating data object relationships for a graphical user interface that provides simple drill-down capability. As illustrated, a given data object 52 with drill-down capability at a given level in the tree has one or more associated child data objects 54a, 54b, . . . , 54n at a next lower level in the tree. Each data object 54a, 54b, . . . , 54n in the next level of the tree may have one or more of its own associated child data objects 56a, 56b, . . . , 56c; 56d, 56e, . . . , 56f; and 56g, 56h, . . . , 56i, respectively, in a next lower level of the tree. Each data object 56a, . . . , 56i in this next lower level of the tree may have one or more of its own associated child data objects in a next lower level of the tree, and so on until the displayed data object is positioned in the lowest level of the tree. In the embodiment shown in FIG. 2A, each child data object has only a single parent data object. This embodiment allows simple tracking of the return path for the drill-up mechanism since any data object can have only one parent link.

In some instances, information in a particular data object may be related to information in more than one data object. If this is the case, then in the simple tree diagram model 50, the particular data object may be duplicated so that it may be reached from more than one parent. FIGS. 2B and 2C illustrate respective data object relationships tree diagram models 60 and 70 that avoid this type of data object duplication. FIG. 2B illustrates a section of the tree 60 having a plurality of data objects 62, 64a, 64b, 66a, 66b, 66c, 66d, 66e, and 66f, where a particular data object 66d is displayed when drilled down from one of two possible parent data objects 64a, 64b on a next higher level. In FIG. 2B, each of the parent data objects 64a, 64b of the shared data object 66d reside on the same tree level. However, this need not be the case. FIG. 2C illustrates a tree model 70 having a plurality of data objects 72, 74a, 74b, 76a,76b, 76c, 76d, and 76e where the parent data objects 72 and 74a of a shared data object 74b reside on different tree levels.

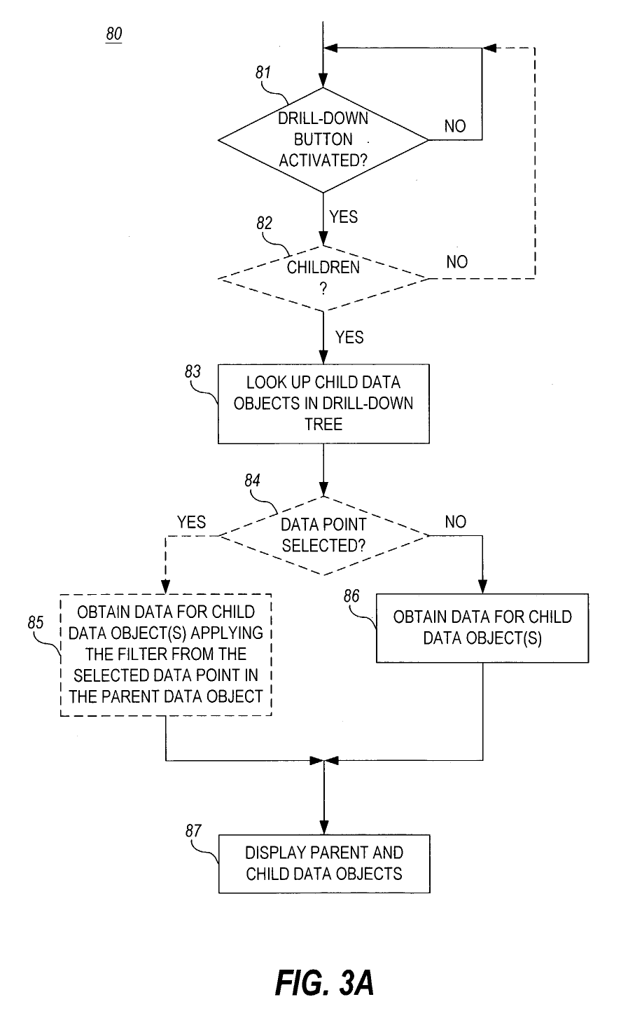

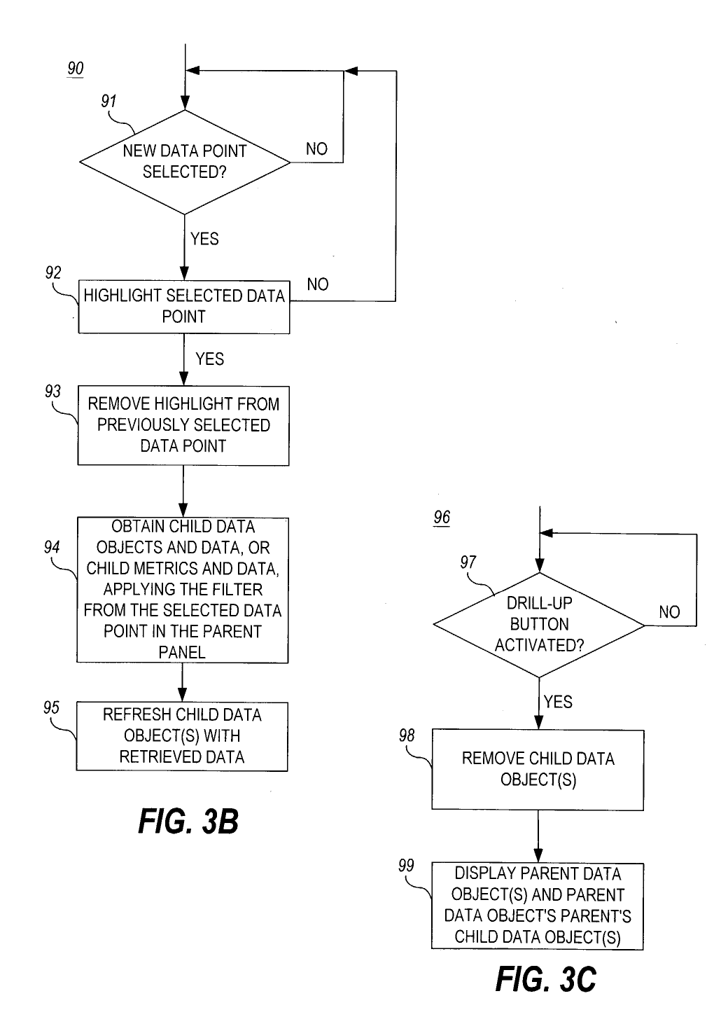

Turning now to the operation of the invention, FIG. 3A describes the actions taken by a graphical user interface when a drill-down mechanism of a data object (such as drill-down mechanism 16a in data object 10a of FIG. 1A) is activated. As illustrated, the method 80 monitors the activation of the drill-down mechanism in step 81. As long as the drill-down mechanism is not activated, the method 80 continues to monitor activation of the drill-down mechanism. When the drill-down mechanism is activated (for example, in a one-step-activation method such as a mouse point-and-click action on a selectable data point or on the drill-down mechanism 16a of data object 10a), the method 80 determines in step 82 whether any child data objects exist for the selected data object associated with the drill-down mechanism (for example by performing a child data object look-up in a data object tree such as those shown in FIGS. 2A-2C). If the selected data object does not have any associated child data objects, the method 80 returns to monitoring activation of the drill-down mechanism in step 81. (Preferably, no drill-down mechanism 16a is provided in the screen view of a given data object if the given data object does not have any associated child data objects, and therefore step 82 may be skipped). If the selected data object does have associated child data objects, the method 80 looks up the child data objects in step 83. In the preferred embodiment, the graphical user interface supports individual data point selection by the operator. In this case, the selection of an individual data point from the selected data object automatically activates the drill-down mechanism to obtain relevant child data objects detailing additional information specific to the selected data point. Accordingly, if the graphical user interface supports data point selection by the operator, the method 80 includes a step 84 for determining whether a particular data point was selected. If a data point is selected, the method 80 obtains the data associated with the selected data point for the child data objects in step 85 and displays the parent and child data objects in a step 87. By default, if the graphical user interface does not support individual data point selection, the method 80 then obtains the data for the child data objects in step 85 and displays the parent and child data objects in a step 87.

FIG. 3B describes the actions taken by the graphical user interface which supports data point selection when a data point is selected. As illustrated, the method 90 monitors the selection of a data point in step 91. Selection of the data point may be implemented as a mouse point and click on the data point shown on the screen, a button, a file menu item, a keyboard stroke, or any other appropriate data point selection means. If a non-selected data point is selected, the method 90 highlights the newly selected data point on the display in step 92 and removes the highlight of the previously selected data point (if it exists) on the display in step 93. The method 90 then obtains the data associated with the newly selected data point for the child data objects in step 94 and refreshes the child data objects in a step 95.

FIG. 3C describes the actions taken by the graphical user interface when a drill-up mechanism of a child data object (for example, drill-up mechanism 26a in child data object 20a of FIG. 1B) is activated. As illustrated, the method 96 monitors the activation of the drill-up mechanism in step 97. Upon activation of the drill-up mechanism, the method 96 removes the child data object(s) in step 98 and displays the parent data object and siblings (i.e., the parent data object's child data object(s)) in step 99.

For illustrative purposes, we turn now to a specific application of the invention, namely the use of the graphical user interface with drill-down capability for charted data in a statistical process control application for an automated tester environment. As known in the automated testing industry, automated testers perform various tests on devices in an assembly line setting. Various measurements and attributes are collected from each device and calculations and statistics are made available about the collected group of devices tested. These calculations and statistics may be translated into useful charts such as line graphs and pareto charts which allow the operator to visually detect trends in the attributes and measurements. Depending on the application, these charts may be sufficient for the operator or other engineers to determine if changes need to be made in the process and what changes to make. However, in many instances, detecting a trend is the first step in a long debugging process. In these cases, additional information about the collected data may be useful to know, and/or the data collected may be presented in other visually useful formats with or without data filtering. For example, it may be useful, upon viewing a chart, to view charts of attributes, measurements, and/or metrics collected from individual test stations to determine whether the source of the problem is a single or few test stations. It may also be useful to view charts illustrating the attributes, measurements, and/or metrics of individual devices that were tested. Furthermore, it may be useful to view charts that illustrate a single attribute, measurement, and/or metric taken across the run of devices tested to determine whether that attribute, measurement, and/or metric contributes to the trend is the cause of the trend. There are many possibilities for displaying useful information, and it should be understood that the format and parameters for display will vary from application to application.

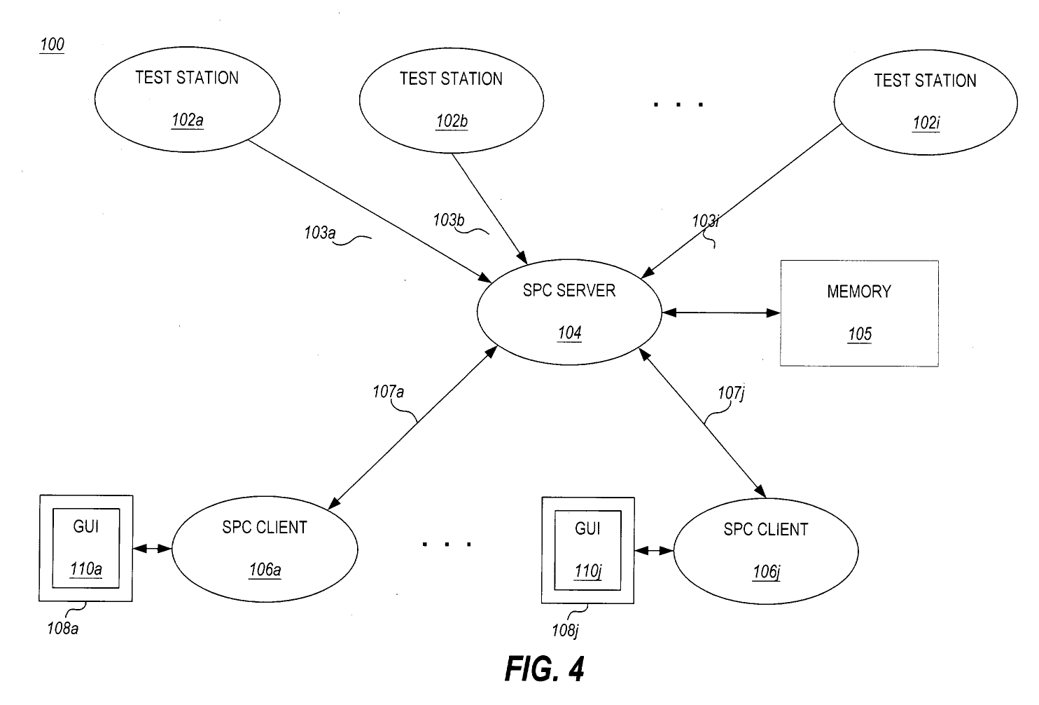

FIG. 4 is a high-level block diagram of an automated tester environment 100. As illustrated, the automated tester environment 100 includes one or more test stations 102a, 102b, . . . , 102i, which collect data 103a, 103b, . . . , 103i on devices under test (not shown). A statistical process control (SPC) server 104 receives test data 103a,103b, . . . , 103i from the test stations 102a, 102b, . . . , 102i and stores it in a memory 105. One or more statistical process control (SPC) clients 106a, . . . , 106j communicate with the SPC server 104 to retrieve relevant test data 107a, . . . , 107j.

In the preferred embodiment, each SPC client 106a, . . . , 106j initiates a session with the SPC server 104. When the SPC server 104 receives new data 103a, 103b, . . . , 103i from a test station 102a,102b, . . . , 102i, the SPC server 104 sends a message to the SPC client sessions 110a, . . . , 110j to indicate that new data 103a, 103b, . . . , 103i from the test station 102a, 102b, . . . , 102i is available. The SPC client(s) 106a, . . . , 106j that are monitoring that particular test station then send a query to the SPC server 104 to retrieve the new data (if interested in the new data) 107a, 107b, . . . , 107i for updating its displayed data in its session graphical user interface 110a, . . . , 110j.

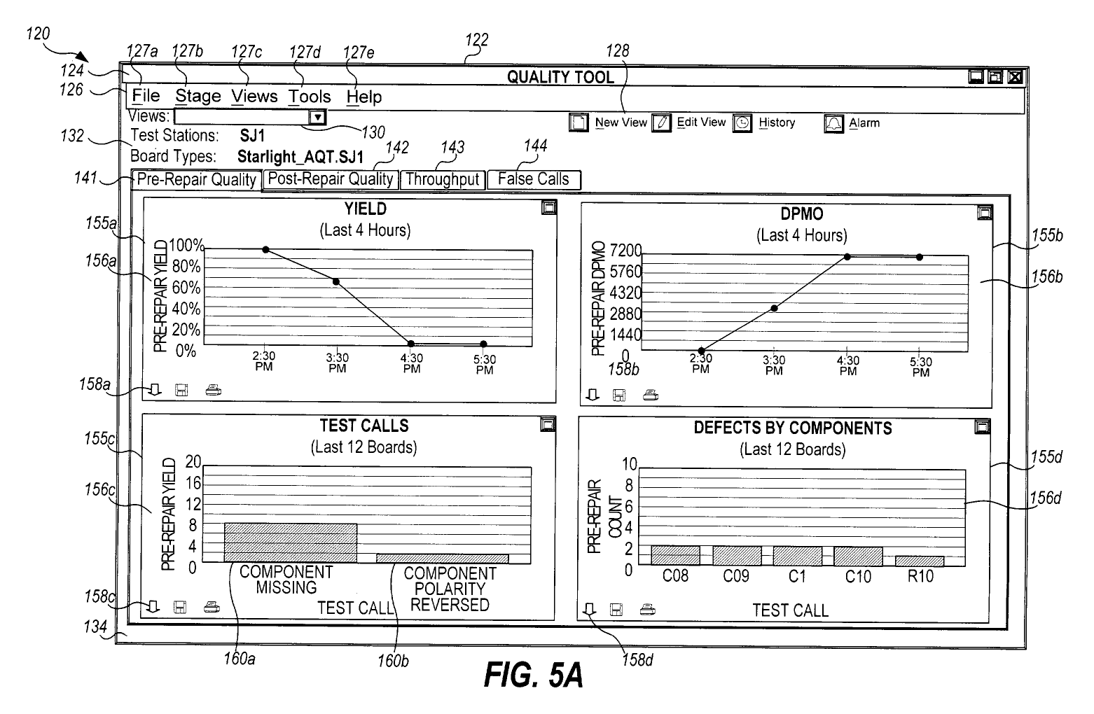

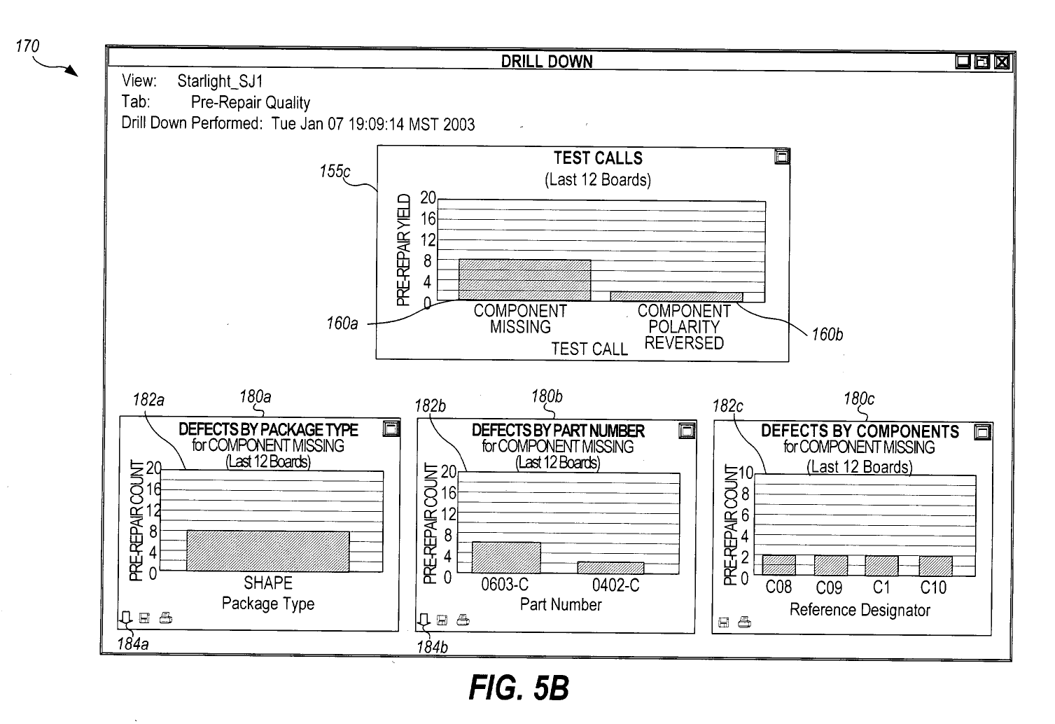

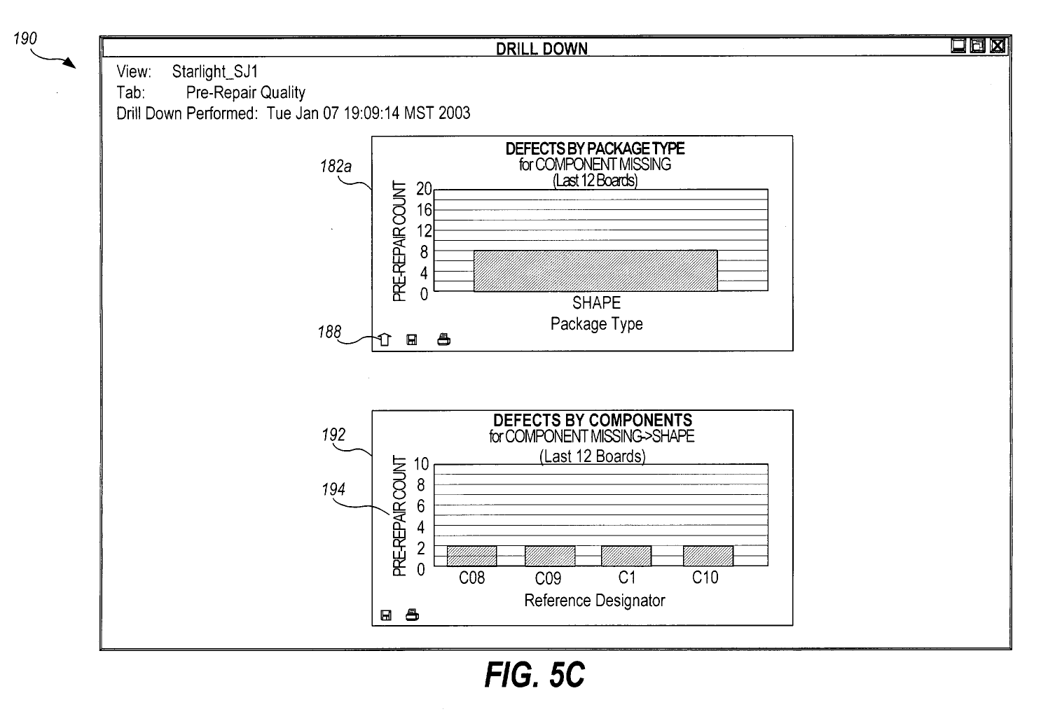

FIG. 5A shows a screen view 120 of a graphical user interface 110a, 110j running on a client 106a, 106j in the automated tester environment 100 of FIG. 4. As illustrated, the screen view 120 comprises a window 122 with a title bar 124, a main menu bar 126, a toolbar 128, a view list 130, view summary information 132, four pre-defined tabs (Pre-Repair Quality 141, Post-Repair Quality 142, Throughput 143, and False Calls 144), and a status bar 134.

The title bar 124 displays the application name and/or other useful identifying information such as the name of the test stage.

In the illustrative embodiment, the main menu bar 126 displays drop-down menus File 127a, Stage 127b, Views 127c, Tools 127d, and Help 127e. The File menu 127 includes menu items that allow the operator to perform file operations (open, save, etc.). The Stage menu 127b allows the operator to set the test stage (x-ray inspection, optical inspection, etc.). The Views menu 127c includes menu items that allow the operator to invoke dialogs to create a new view or edit a saved view. The Tools menu 127d is for menu items such as displaying even logs and configuring the display options. The Help menu 127e includes menu items for accessing the help file of the graphical user interface and displaying the current version of the graphical user interface.

The toolbar 128 displays buttons for the most commonly used menu items in the drop-down menus 127a, 127b, 127c, 127d, 127e.

The view list 130 is a drop-down list of configured views of data. Each view is created using a Create View Wizard invoked on the main toolbar 128 or from the Views drop-down menu 127c. The view list 130 is context sensitive, meaning that the particular views included in the view list 130 depend on the selected stage. Each view in the view list 130 has an associated set of parameters that determines which data objects will appear in the view and how the data is filtered for display in each data object.

The view summary information 132 displays summary information about the currently selected view, and the status bar 134 displays status information for the application. In the illustrative embodiment, the view summary information 132 includes a description of the data view, including a list of the test stations from which data is collected and a description of the device under test, and the status bar 134 displays the name of the operator, the date and time of the last screen refresh, the refresh interval, and the current time.

In the illustrative embodiment, there are four pre-defined tabs: Pre-Repair Quality 141, Post-Repair Quality 142, Throughput 143, and False Calls 144. The Pre-Repair Quality tab 141 includes charts that illustrate the pre-repair yield, the pre-repair DPMO, the pre-repair top failing defects, and the pre-repair top-failing components. The Post-Repair Quality tab 142 includes charts that illustrate the post-repair yield, the post-repair DPMO, the post-repair top failing defects, and the post-repair top-failing components. The Throughput tab 143 includes charts that illustrate the number of boards tested, number of boards repaired, and number of boards completed The False Calls tab 144iincludes charts that illustrate the ratio of false to total calls, the false DPMO, the top false called algorithms, and the top false components.

Each tab 141,142,143, 144 contains one or more data objects. In the illustrative embodiment, each tab includes up to four data objects 156a, 156b, 156c, 156d due to screen size constraints. The data objects 156a, 156b, 156c, 156d are in the form of charts generated from relevant collected data, and each is displayed in a respective separate panel 155a, 155b, 155c, 155d.

The specific charts that belong on each tab are context sensitive and therefore may vary between stages. In the illustrative embodiment, the Pre-Repair Quality tab 141 is shown as selected. As illustrated, the Pre-Repair Quality tab 141 includes four panels 155a, 155b, 155c, 155d, each displaying a data object 156a, 156b, 156c, 156d in the form of a chart. Each data object 156a, 156b, 156c, 156d has associated drill-down capability, which in the preferred embodiment, is implemented both as a panel drill-down button 158a, 158b, 158c, 158d, and also as selectable data points within each data object 156a, 156b, 156c, 156d. To this end, in the preferred embodiment, there are therefore two different methods for activating drill-down action. In the first method, the respective drill-down button 158a, 158b, 158c, 158d of a panel 155a, 155b, 155c, 155d may be selected to activate drill-down, and in the second method, a particular data point in the data object may be selected to activate drill-down. Selection may be achieved by pointing to and clicking the button or data point, a file menu item, a hyperlink, a keyboard stroke, or other commonly known user input means. In the preferred embodiment, activation of the drill-down mechanism is achieved in a one-step activation method such as a mouse point-and-click action on a selectable drill-down button or selectable data point. Once a drill-down mechanism has been activated, any drill-down (also called “child”) data objects associated with the data object from which the drill-down mechanism was invoked (also called “parent” data object) are displayed. In the preferred embodiment, the drill-down data objects are displayed as an amodal dialog in a pop-up window. In alternative embodiments, the drill-down data objects may be displayed within the selected tab 141, 142, 143, 144, or may replace the displayed information in the window of the parent data object screen view.

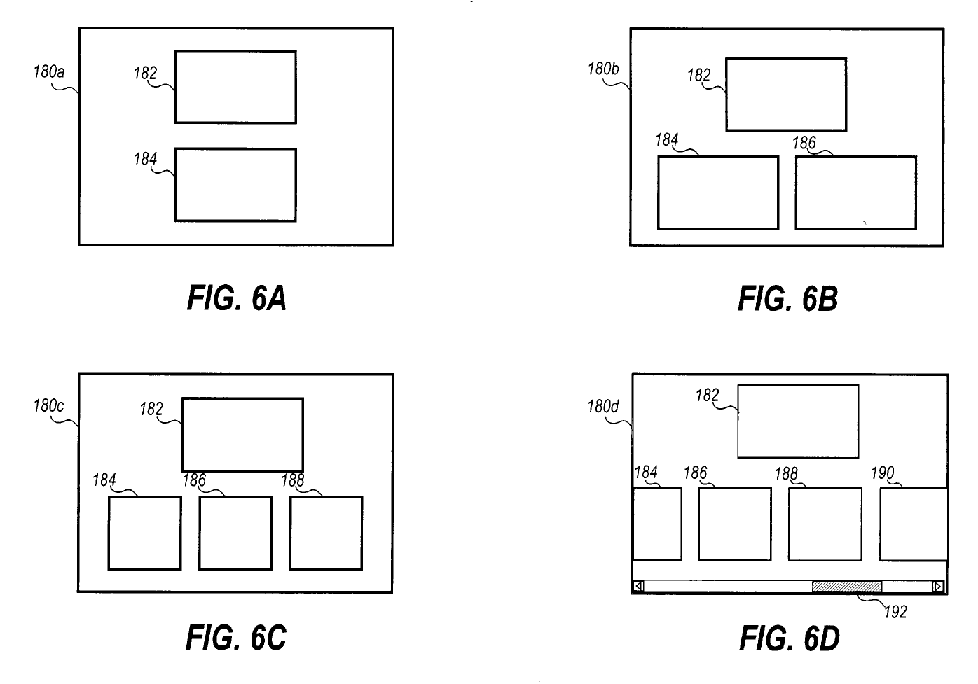

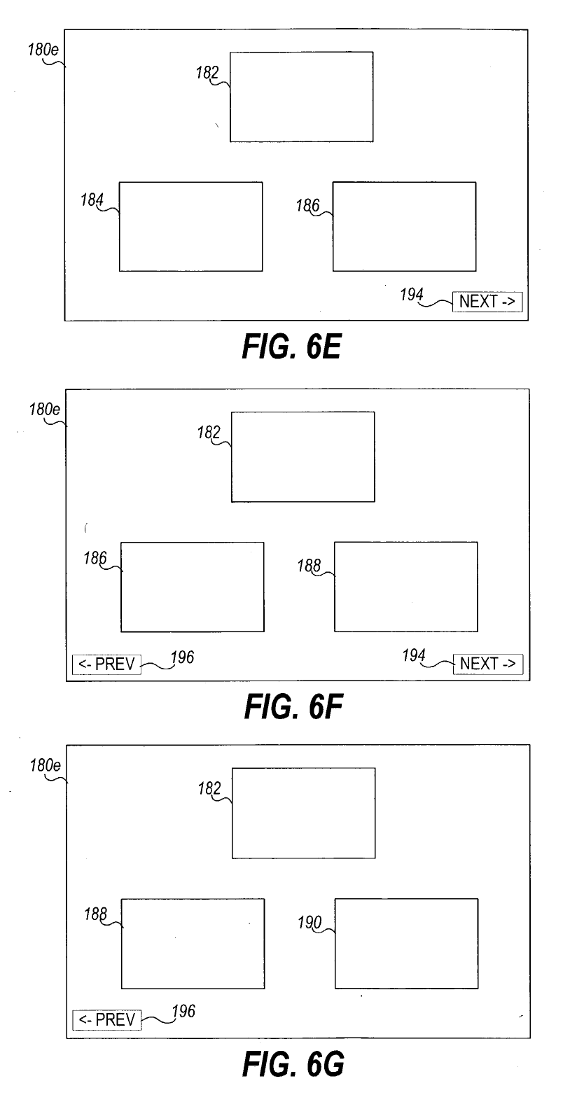

In the dialog that displays the drill-down data objects, the content of the parent data object is preferably also displayed to allow for same-screen comparison with its drill-down data objects. FIGS. 6A, 6B, 6C, 6D, 6E, 6F, and 6G variously show the preferred layout of the data objects for drill-downs with one, two, three, and n (greater than three) child data objects. As shown, in each layout the content of the parent data object 182 is preferably displayed on the top half of the pop-up window 180a, 180b, 180c, 180d and the children data objects 184, 186, 188, 190 are displayed below. As shown in FIGS. 6A, 6B, and 6C, due to screen size constraints, a maximum of three child data objects are preferably displayed at a time on one screen. Of course, it will be appreciated that the maximum number of simultaneously displayed child data objects may be any number appropriate to the graphical user interface application subject to limitations of the viewer's ability to comfortably view the content of each of the child data objects. If more than three child data objects 184, 186, 188, 190 are to be displayed, in one embodiment shown in FIG. 6D, the pop-up window preferably includes a scroll-bar 192 (either horizontal as shown, or vertical) to allow any number of child data objects to be displayed. In this embodiment, each child data object will be of a predetermined size and at any given time an operator can view a subset of the available child data objects as determined by the operator-selectable position of the scroll bar 192. In the alternative, if more than three child data objects 184, 186, 188, 190 are to be displayed, in another embodiment shown in FIGS. 6E, 6F, and 6G, the pop-up window 180e (shown in FIG. 6E) displays a subset 184, 182 of the data objects and preferably includes a Next button 194 which when selected causes at least one 184 of the displayed child data objects to be removed from the display and at least one additional child data object 186 to be displayed. If there exist at least one additional child data object 190 that has not yet been displayed, the pop-up window 180f (shown in FIG. 6F) which displays the at least one additional child data object 188 includes a Next button 194 and a Previous button 196. The Next button 194, when selected, causes at least one 186 of the displayed child data objects to be removed from the display and at least one more additional child data object 190 to be displayed. The Prev button 196, when selected, causes the immediate previously displayed child data objects 184, 186 to be displayed. When a pop-up window 180g displays the last child data object 190, the window 180g (shown in FIG. 6G) includes only a Prev button 196 to redisplay the immediate previously displayed child data objects 186, 188.

Returning to FIG. 5, each panel 155a, 155b, 155c, 155d displays data objects 156a, 156b, 156c, 156d of interest specific to the context (i.e., the test stage and device under test) as configured by the Administrator. In particular, panel 155a displays a data object 156a in the form of a line graph illustrating the first pass yield obtained over time (number of devices under test (DUTs) that pass on first test). Panel 155b displays a data object 156b illustrating the number of defects per million opportunities (DPMO) (i.e., the number of DUTs that fail per million DUTs). Panel 155c displays a data object 156c illustrating the number of test calls. Parent panel 155d displays a data object 156d illustrating the number of failed components by component type. As illustrated, each panel 155a, 155b, 155c, 155d displays useful information in a visual manner. For example, in the illustrative example, the First Pass Yield chart 156a in panel 155a indicates a decreasing first pass yield trend over the last 4 hours with a significant drop in the hours between 2:30 PM and 4:30 PM. Also in the illustrative example, the DPMO chart 156b in panel 155b shows a sharp increase in defects between the same hours. The Test Calls chart 156c in panel 155c illustrates that most failures are occurring as a result of a missing component. The Failed Components chart 156d in panel 155d illustrates that the failures are distributed fairly evenly across the identified components most common defect type is a missing component.

To obtain additional useful information from a given chart 156a, 156b, 156c, 156d, the operator may click on the drill-down button 158a, 158b, 158c, 158d of the chart's associated panel 155a, 155b, 155c, 155d, and display within the tab will display additional useful information in one or more child panels. In the alternative, the operator may click on a data point of the chart 156a, 156b, 156c, 156d to display child data objects associated with the selected chart with data specific to the selected data point. In either case, the child data objects are pre-configured and displayed automatically upon activation of the drill-down button 158a, 158b, 158c, 158d or data point.

For example, with reference to the Test Calls chart 156c in panel 156c of FIG. 5A, there are two data points—the Components Missing bar 160a and the Component Polarity Reversed bar 160b. The operator may obtain additional useful information about the “Component Missing” data point 160a by selecting (i.e., clicking on) the Component Missing bar 160a. The pre-configured child data objects associated with the Component Missing bar 160a of the Test Calls data object 156c are automatically displayed, as shown in FIG. 5B, upon selection of the Component Missing bare 160a of the screen 120.

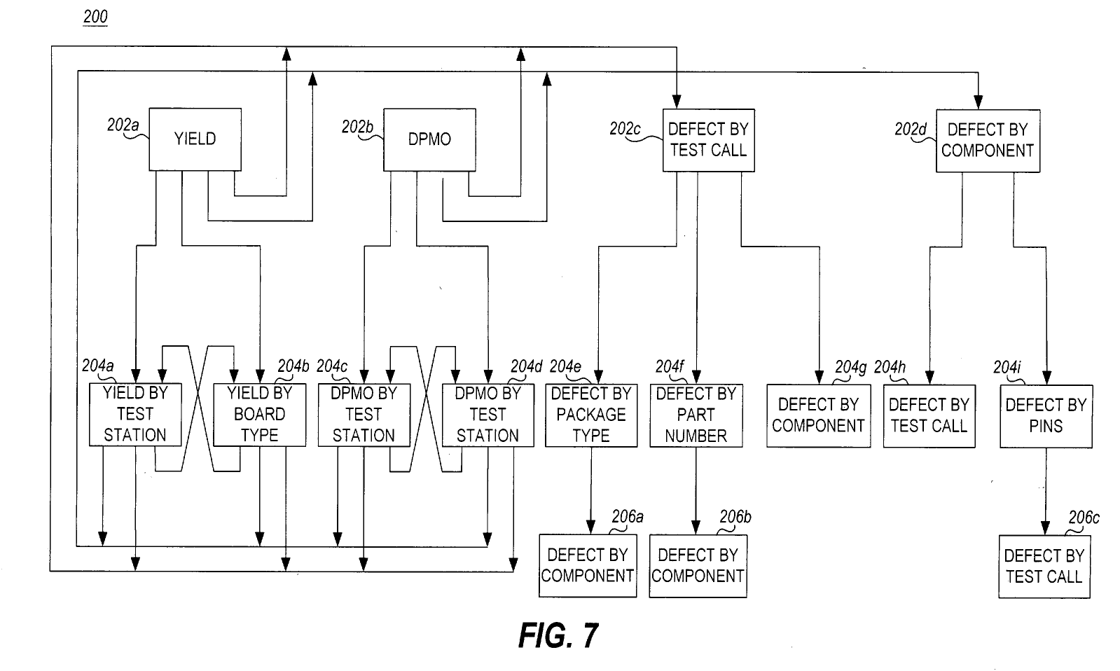

FIG. 7 shows an example drill-down tree 200 for the Pre-Repair Quality tab 141 of FIG. 5A. At the highest level of the tree are the default charts (to be displayed as data objects) 202a, 202b, 202c, and 202d that are to be displayed in panels when the Pre-Repair tab 141 is first selected. These charts include a Yield chart 202a, a DPMO (Defects Per Million Opportunities) chart 202b, a Test Calls (Defect by Type) chart 202c, and a Defect By Component chart 202d. A connecting arrow is used to indicate a parent-to-child relationship between the chart from which the arrow originates and the chart pointed to by the arrow. Accordingly, the connecting arrows originating from a parent chart to one or more child charts indicate the drill-down path associated with each chart in the tree 200. As illustrated by tree 200, each chart may operate as a parent chart, a child chart, or both. For example, charts 202a, 202b each operate only as a parent chart, while charts 204g, 204h, 206a, 206b, and 206c each operate only as a child chart. In contrast, charts 202c, 202d, 204a, 204b, 204c, 204d, 204e, and 204f each operate as both a parent chart and a child chart.

FIG. 5B is an example drill-down amodal dialog 170 that is displayed when the Components Missing bar 160a of data object 156c in parent panel 155c of FIG. 5A is selected. As illustrated, the amodal dialog 170 includes the parent data object 156c and three child data objects 192a, 192b, 192c respectively displayed in panels 190a, 190b, 190c according to the layout of FIG. 6C. The drill-down tree 200 of FIG. 7 determines the content of the child panels 190a, 190b, 190c. Accordingly, because parent data object 156c is a Test Calls chart 202c, then according to the drill-down tree 200, the panel 190a includes as its data object 192a a Defect by Package Type chart 204e specific to the Components Missing data point 160a. Likewise, panel 190b includes as its data object 192b a Defect by Part Number chart 204f specific to the Components Missing data point 160a, and panel 190c includes a Defect by Components chart 204g specific to the Components Missing data point 160a.

As shown in FIG. 5B, each child panel 190a, 190b, 190c includes a drill-up mechanism 172. In the illustrative preferred embodiment shown, since all drill-ups from any of the data objects in the panels 190a, 190b, 190c return the screen view to the Pre-Repair tab 141 in FIG. 5A, the drill-up mechanism 172 is implemented as the close button of the amodal dialog. Alternatively, the drill-up mechanism may be implemented as a separate drill-up button in each panel 190a, 190b, 190c, a file menu item, a hyperlink, a keyboard stroke, or any or other convenient activation mechanism appropriate to the particular graphical user interface 2.

If a displayed child data object has its own associated child data objects, it will also provide its own drill-down mechanism. For example, as shown in FIG. 7, the Defects by Package Type chart 204e has an associated child chart, Defect by Components chart 206a. Accordingly, panel 180a, which includes as its data object 182a a Defect by Package Type chart 204e also includes drill-down mechanisms in the form of both a drill-down button 196b and data point selection (on the Shape bar 186a).

FIG. 5C illustrates an amodal dialog 190 that may be displayed when the Shape bar data point 186a of the Defects by Package Type data object 182a of child panel 180a in modal dialog 170 is selected. The dialog 190 displays the parent data object 182a and its child data object 194 in a panel 192. Child data object 194 is a Defect by Component chart 204f according to the data object tree 200 of FIG. 7. Because the Shape bar data point 186a of the Defects by Package Type data object 182a was selected, the Defect by Component chart data object 194 is specific to the failed components for component missing->shape. Since from the data object tree 200 there are no child charts associated with the Defects by Components chart 206a, the data object 182a provides no drill-down capability. However, since the dialog 190 was reached through another child data object 182a, the child data object 182a displayed in dialog 190 includes a drill-up mechanism in the form of a drill-up button 188. Selecting the drill-up button 188 removes the dialog 190 from the screen and returns the screen view to the parent dialog 170 as shown in FIG. 5B.

Returning to FIG. 5B, in the illustrative example, child panel 180a displays a chart 182a of Failed Components by Package Type for the Component Missing defect type. It is clear from this chart that almost all of the Component Missing defects occur with a particular packet type—namely package type “Shape”. As also shown, child panel 180b displays a chart 182b of Failed Components by Part Number for the Component Missing defect type. It is clear from this chart 182b that most of the missing components are identified by part number “0603-C”. Child panel 180c displays a chart 182c of Failed Components for the Component Missing defect. This chart 182c indicates that the Component Missing defect is evenly distributed among all displayed component identifiers.

When the Shape bar 186a in the Failed Components by Package Type chart 182a is selected, the child data object chart 194 in drill-down dialog 190 illustrates that the Component Missing defect is evenly distributed among all displayed component identifiers.

As illustrated, a lot of information can be ascertained from the charts 182a, 182b, 182c displayed in the three child panels 180a, 180b, 180c. In particular, the Component Missing defect appears to be attributable to a particular package type “Shape”, where the failing part numbers are likely packaged according to the failing package type and most of the failing components are embodied by one of the failing part numbers “0603-C”. Accordingly, the operator can quickly pinpoint or at least narrow the possibilities of the root cause of the DUT or process defect(s) simply by visually analyzing the displayed parent-child data objects. This analysis is assisted in the preferred embodiment in which the selected parent and its child data objects are simultaneously displayed. In addition, the selection of child data objects to be displayed for a given parent data object are pre-configured such that the displayed child data objects are those that make the most sense given the contents of the parent data object, the selected data point (if data point selection is implemented), the available data, and the real debugging problem under consideration.

The above-described invention is advantageous over the prior art for several reasons. First, the automatic pre-determined mapping of child data objects to parent data objects removes the task of correlating meaningful charts and data filters applicable to the real problem under analysis from the individual operator. The mapping need be set up only once by the graphical user interface designer or administrator, taking into account the actual problem under analysis. Second, the simultaneous display of a parent data object's child objects allows side-by-side comparison of data. Finally, in the preferred embodiment which implements a one-step-activation of its drill-down mechanism, the graphical user interface operator can quickly access any drill-down data in a meaningful format automatically.

Although this preferred embodiment of the present invention has been disclosed for illustrative purposes, those skilled in the art will appreciate that various modifications, additions and substitutions are possible, without departing from the scope and spirit of the invention as disclosed in the accompanying claims. It is also possible that other benefits or uses of the currently disclosed invention will become apparent over time.

What is claimed is:

1. A graphical user interface viewable on a display screen, comprising:
a first display screen view comprising:
a data object;
a drill-down mechanism associated with said data object which upon activation automatically causes a plurality of child data objects associated with said data object to be displayed in a second display screen view.

2. A graphical user interface in accordance with claim 1, wherein:
all of said plurality of child data objects are viewable simultaneously within said second display screen view.

3. A graphical user interface in accordance with claim 2, wherein:
said second display screen view comprises a drill-up mechanism which when activated removes said second display screen view and refreshes said display screen to display said first display screen view.

4. A graphical user interface in accordance with claim 2, wherein:
said drill-down mechanism comprises a drill-down button which when selected causes activation of said drill-down mechanism.

5. A graphical user interface in accordance with claim 2, wherein:
said drill-down mechanism comprises one or more selectable data points in said data object each of which when selected causes activation of said drill-down mechanism, wherein said displayed plurality of child data objects includes data specific only to said selected data point.

6. A graphical user interface in accordance with claim 1, wherein:
only a subset of said plurality of child data objects are viewable at a given time within said second display screen view, and said second display screen view comprises a scroll bar which when selected controls which of said plurality of child data objects are currently viewable within said second display screen view.

7. A graphical user interface in accordance with claim 6, wherein:
said second display screen view comprises a drill-up mechanism which when activated removes said second display screen view and refreshes said display screen to display said first display screen view.

8. A graphical user interface in accordance with claim 6, wherein:
said drill-down mechanism comprises a drill-down button which when selected causes activation of said drill-down mechanism.

9. A graphical user interface in accordance with claim 6, wherein:
said drill-down mechanism comprises one or more selectable data points in said data object each of which when selected causes activation of said drill-down mechanism, wherein said displayed plurality of child data objects includes data specific only to said selected data point.

10. A graphical user interface in accordance with claim 1, wherein:
only a subset of said plurality of child data objects are viewable at a given time within said second display screen view, and said second display screen view comprises a next button which when selected causes a third display screen view to be displayed on said display screen, said third display screen view displaying at least one of said plurality of child data objects that are not included in said subset of said plurality of child data objects and comprising a previous button which when selected causes said third display screen view to be removed from said display screen and said second display screen view to be displayed.

11. A graphical user interface in accordance with claim 10, wherein:
said second display screen view comprises a drill-up mechanism which when activated removes said second display screen view and refreshes said display screen to display said first display screen view.

12. A graphical user interface in accordance with claim 10, wherein:
said drill-down mechanism comprises a drill-down button which when selected causes activation of said drill-down mechanism.

13. A graphical user interface in accordance with claim 10, wherein:
said drill-down mechanism comprises one or more selectable data points in said data object each of which when selected causes activation of said drill-down mechanism, wherein said displayed plurality of child data objects includes data specific only to said selected data point.

14. A graphical user interface in accordance with claim 1, wherein:
said second display screen view comprises a drill-up mechanism which when activated removes said second display screen view and refreshes said display screen to display said first display screen view.

15. A graphical user interface in accordance with claim 1, wherein:
said drill-down mechanism comprises a drill-down button which when selected causes activation of said drill-down mechanism.

16. A graphical user interface in accordance with claim 1, wherein:
said drill-down mechanism comprises one or more selectable data points in said data object each of which when selected causes activation of said drill-down mechanism, wherein said displayed plurality of child data objects includes data specific only to said selected data point.

17. A graphical user interface in accordance with claim 1, wherein:
said data object is displayed simultaneously with said plurality of child data objects.

18. A graphical user interface in accordance with claim 1, wherein:
said first display screen view further comprises:
at least one additional data object, said at least one additional data object having an associated drill-down mechanism which upon activation automatically causes a plurality of child data objects associated with said at least one additional data object to be displayed in an associated additional display screen view.

19. A method for displaying child data objects associated with parent data objects in a graphical user interface, said method comprising the steps of:
displaying one or more parent data objects in a first display screen view on a display screen, each said one or more parent data objects having a respective drill-down mechanism;
monitoring activation of each of said drill-down mechanisms; and
upon activation of one of said drill-down mechanisms, simultaneously displaying a plurality of child data objects associated with said respective parent data object associated with said activated drill-down mechanism in a second display screen view.

20. A method in accordance with claim 19, comprising:
monitoring a drill-up mechanism in said second display screen view;
upon activation of said drill-up mechanism:
removing said second display screen view; and
re-displaying said first display screen view.

21. A method in accordance with claim 19, wherein at least one of said drill-down mechanisms comprises one or more selectable data points in an associated parent data object, said method further comprising:
monitoring selection of said one or more data points in said associated parent data object; and
upon selection of one of said one or more data points, displaying said one or more child data objects associated with said parent data object in said second display screen view, including data specific only to said selected data point.

22. A method in accordance with claim 21, comprising:
monitoring a drill-up mechanism in said second display screen view;
upon activation of said drill-up mechanism:
removing said second display screen view; and
re-displaying said first display screen view.

23. A graphical user interface viewable on a display screen, comprising:
a first display screen view comprising:
a data object;
a one-step-activation drill-down mechanism associated with said data object which upon one-step-activation automatically causes a plurality of child data objects associated with said data object to be displayed in a second display screen view.

24. A graphical user interface in accordance with claim 23, wherein:
said second display screen view comprises a drill-up mechanism which when activated removes said second display screen view and refreshes said display screen to display said first display screen view.

25. A graphical user interface in accordance with claim 23, wherein:
said drill-down mechanism comprises a drill-down button which when selected causes activation of said drill-down mechanism.

26. A graphical user interface in accordance with claim 23, wherein:
said drill-down mechanism comprises one or more selectable data points in said data object each of which when selected causes activation of said drill-down mechanism, wherein said displayed plurality of child data objects includes data specific only to said selected data point.
